(19) United States
(12) Patent Application Publication
(10) Pub. No.: US 2021/0103598 A1
(43) Pub. Date: Apr. 8, 2021

(54) MANAGING PERSISTENT HANDLE INFORMATION FOR A FILE

(71) Applicant: HEWLETT PACKARD ENTERPRISE DEVELOPMENT LP, Houston, TX (US)

(72) Inventors: Priya Pappanaickenpalayam Muthuswamy, Bangalore (IN); Ashok Ramakrishnan, Apex, NC (US)

(21) Appl. No.: 16/593,909

(22) Filed: Oct. 4, 2019

(51) Int. Cl. G06F 16/27; G06F 16/23; G06F 16/22; G06F 16/178; G06F 16/188

(52) U.S. Cl. CPC G06F 16/27; G06F 16/2379; G06F 16/188; G06F 16/178; G06F 16/2228

(57) ABSTRACT

Examples described herein relate to a method for managing persistent handle state information. The persistent handle state information is generated for a file associated with a resource based on access of the file. The file is stored in a file system instance corresponding to the resource. The persistent handle state information corresponding to the file is stored in a state file in the file system instance corresponding to the resource.

### BACKGROUND

Computing systems may store data. Data may be served via storage protocols. Computing systems may operate to store data with high or continuous availability. For example, data may be replicated between computing systems in a failover domain, and a computing system may take over storage access responsibilities for a failed computing system.

### BRIEF DESCRIPTION OF THE DRAWINGS

These and other features, aspects, and advantages of the present specification will become better understood when the following detailed description is read with reference to the accompanying drawings in which like characters represent like parts throughout the drawings, wherein:

FIG. 1 illustrates a computing node that manages persistent handle state information, in accordance with an example;

FIG. 2 illustrates a file system instance including a state file storing persistent handle state information, in accordance with an example;

FIG. 3 illustrates a file format of the state file of FIG. 2, in accordance with an example;

FIG. 4 illustrates a cluster of computing nodes, in accordance with an example;

FIG. 5 is a block diagram depicting a processing resource and a machine readable medium encoded with example instructions to manage persistent handle state information, in accordance with an example;

FIG. 6 is a flow diagram depicting a method for managing persistent handle state information, in accordance with an example; and

FIG. 7 is a flow diagram depicting a method for managing persistent handle state information, in accordance with another example.

It is emphasized that, in the drawings, various features are not drawn to scale. In fact, in the drawings, the dimensions of the various features have been arbitrarily increased or reduced for clarity of discussion.

### DETAILED DESCRIPTION

The following detailed description refers to the accompanying drawings. Wherever possible, same reference numbers are used in the drawings and the following description to refer to the same or similar parts. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system. The term “and/or” as used herein refers to and encompasses any and all possible combinations of the associated listed items. It will also be understood that, although the terms first, second, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

Data may be stored on computing systems (hereinafter referred to as computing nodes), such as, but not limited to, servers, computer appliances, workstations, storage systems, or converged or hyperconverged systems. To store data, some computing nodes may utilize a data virtualization platform that abstracts, into data stores (e.g., a virtual or logical storage), aspects of a physical storage on which the data is physically stored (e.g., aspects such as addressing, configurations, etc.). The physical storage may be implemented using hardware, such as, hard disk drives, solid state drives, and the like. The data stores may be referenced by a user environment (e.g., to an operating system, applications, processes, etc.). The data virtualization platform may also provide data services such as deduplication, compression, replication, and the like.

In some implementations, a data store may be implemented, maintained, and managed, at least in part, by one or more virtual controllers. A virtual controller may be a virtual machine executing on hardware resources, such as a processor and memory, with specialized processor-executable instructions to establish and maintain the data store. In some instances, the data store may be an object-based data store. In an object-based data store, data may be stored as objects in an object store. User accessible files and directories may be made up of multiple objects. Each object may be identified by a signature (also referred to as an object fingerprint), which, in some implementations, may include a cryptographic hash digest of the content of that object. The signature can be correlated to a physical address (i.e., disk location) of the object's data in an object index. Objects in the object-based data store may be hierarchically related to a root object in an object tree (e.g., a Merkle tree) or any other hierarchical arrangement (e.g., directed acyclic graphs, etc.). The hierarchical arrangement of objects may be referred to as a file system instance or a hive. In some instances, one or more file system instances may be dedicated to an entity, such as a particular virtual machine or virtual controller, a database, a user, or a client. Objects in the object store may be referenced in the one or more file system instances.

In order to provide high or continuous availability of data, computing nodes participating a virtualized distributed network may be arranged into failover domains. For example, a failover domain may be a cluster of computing nodes connected over a network. In some cases, data, for example, a file system instance, may be replicated between two or more computing nodes in the cluster. Occasionally, a computing node in the cluster may become unavailable to service client requests to access or update data. Unavailability of the computing node may arise, for example, due to a network partition, a partial or complete failure of that computing node, a disconnection of that computing node from the network, or other situations. Therefore, it is desirable to maintain high-availability (HA) of the file system instance across at least two computing nodes in the cluster. In some examples, the file system instance corresponding to a VM, for example, may be stored in at least two computing nodes as replicas, for example, a replica of the file system instance may be stored locally on a computing node hosting the VM while another replica may be stored on a different computing node in the cluster.

Generally, when a resource such as the virtual machine is accessed by a client, one or more files corresponding to the virtual machine may be accessed. Depending on the access of the files, state information, such as, a persistent handle state information corresponding to each file may be created and maintained in a data store on the computing node hosting the virtual machine. The persistent handle state information may facilitate continuity of access of the file in case a connection with a computing node hosting the file is lost and a reconnect request is received within a time-out duration from the loss of the connection. In some examples, the persistent handle state information may also facilitate transparent failover in a cluster of computing nodes. Types of the persistent handle state information may include, but are not limited to, an open handle, a share-mode lock handle, and a lease handle.

Traditionally, the persistent handle state information for all resources, for example, virtual machines, is stored in a file in the distributed storage. By way of example, the file containing the persistent handle state information may be stored in a common file system instance for all virtual machines. Such storage of the file containing the persistent handle state information may pose several challenges. For example, if the file which holds the persistent handle state information is corrupted, all the virtual machines may be affected as the state information for all the virtual machines is stored in this file. Further, during failover to a surviving computing node, if a file system instance for a virtual machine is recovered prior to the file system instance that holds the file containing the persistent handle state information, then also the virtual machines would be impacted as a hypervisor expects the state information of the virtual machines to be available within a specified time period to keep the virtual machines running. Moreover, cleaning of stale entries in the file containing the persistent handle state information would require the complete traversal of the file containing the persistent handle state information as this file holds the persistent handle state information for all the virtual machines hosted on that computing node. The complete traversal of the file containing the persistent handle state information may be performed to decide whether it is stale or not.

In accordance with some aspects of the present disclosure, when a file corresponding to a resource is being accessed, persistent handle state information for the file is generated based on access of the file. Examples of the resource may be a virtual machine, a database, a client, an application or computer program, a container, a containerized application, a folder, or combinations thereof. The file is stored in a file system instance corresponding to the resource. The persistent handle state information corresponding to the file is stored in a state file. In particular, in accordance with the aspects of the present specification, the state file that is also stored in the file system instance which stores the file corresponding to which the state file contains the persistent handle state information.

In some examples, storing both the file and corresponding state file in the same file system instance may lead to improved reliability of a system. For instance, as both the file and the corresponding state file are stored in the same file system instance, as soon as the file system instance is available for access, the state file associated with the each of the files in the file system instance is also available. Accordingly, possibilities for unavailability of the persistent handle state information when any file in the file system instance is accessed may be avoided or minimized. Further, if any state file gets corrupted, only a particular resource (e.g., virtual machine) corresponding to the corrupted state file would be impacted (e.g., enter into power OFF state). Consequently, the impact would be contained and the impacted resource can be recovered (i.e., brought to a normal operation) later. Moreover, cleaning of the state files in accordance with the aspects of the present disclosure would be easy as a traversal of only the state files corresponding to the resource is required when the resource is accessed. The effort to traverse corresponding state files in this manner is may be less in comparison to the effort in traversing the state file holding persistent handle state information all resources hosted on a computing node.

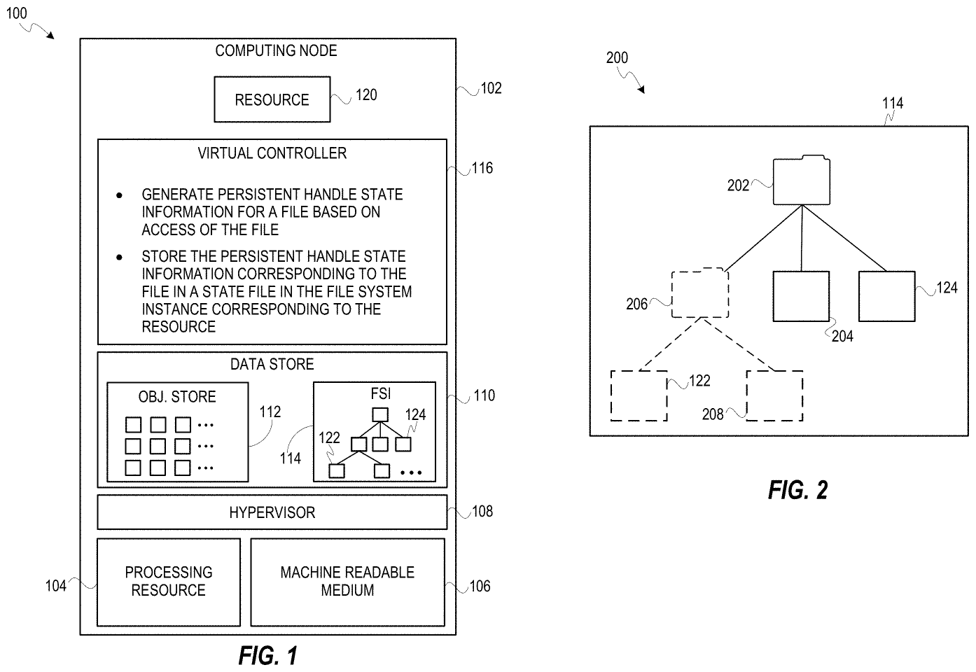

Referring now to drawings, in FIG. 1, a system 100 for managing persistent handle state information is presented, in accordance with an example. The system 100 includes a computing node 102. The computing node 102 may be a computer, a device including a processor or microcontroller and/or any other electronic component, device or system that performs one or more operations according to one or more programming instructions. Examples of the computing node 102 may include, but are not limited to, a desktop computer, a laptop, a smartphone, a server, a computer appliance, a workstation, a storage system, or a converged or hyperconverged system, and the like.

As depicted in FIG. 1, the computing node 102 may include a processing resource 104 and a machine readable medium 106. Non-limiting examples of the processing resource 104 may include a microcontroller, a microprocessor, central processing unit core(s), an application-specific integrated circuit (ASIC), a field programmable gate array (FPGA), etc. The machine readable medium 106 may be a non-transitory storage medium, examples of which include, but are not limited to, a random access memory (RAM), a read-only memory (ROM), an electrically erasable programmable read-only memory (EEPROM), a flash memory, a hard disk drive, etc. The processing resource 104 may execute instructions (i.e., programming or software code) stored on the machine readable medium 106. Additionally or alternatively, the processing resource 104 may include electronic circuitry for performing the functionality described herein.

Further, in some examples, the computing node 102 may include a hypervisor 108. The hypervisor 108 may be a computer program, firmware, or a hardware that may facilitate hosting of one or more operating system instances on a common processing resource. Such operating system instance hosted or installed on the hypervisor 108 may be referred to as a virtual machine. Accordingly, the hypervisor 108 may provide a host operating system for the virtual machine. The hypervisor 108 may be type-1 hypervisor (also referred to as “bare-metal hypervisor”) or type-2 (also referred to as “hosted hypervisor”). The type-1 hypervisor may be installed on the hardware (e.g., the processing resource 104, the machine readable medium 106) of the host computing node 102 without any intermediate operating system. The type-2 hypervisor may be installed on top of an operating system running on the host computing node 102 without any intermediate operating system.

Further, in some examples, the computing node 102 may also host a resource 120. For example, the resource 120 may be hosted on the hypervisor 108 executing on the processing resource 104. Examples of the resource 120 may be the virtual machine, database, a client, an application or computer program, a container, a containerized application, a folder, or combinations thereof. Although the computing node 102 is shown to host a resource 120, in some examples, the computing node 102 may host more than one resource as well, without limiting the scope of the present disclosure.

Furthermore, the computing node 102 may include a data store 110. The data store 110 may represent a virtualized storage that may include aspects (e.g., addressing, configurations, etc.) abstracted from data stored in a physical storage (not shown). The data store 110 may be presented to a user environment (e.g., to the virtual machines, an operating system, applications, processes, etc.) hosted on the computing node 102. In some examples, the data store 110 may also provide data services such as deduplication, compression, replication, and the like.

In some examples, the data store 110 may be an object-based data store. In the object-based data store 110, data may be stored as objects. The data store 110 may include an object store 112. User accessible files and directories may be made up of multiple objects. Each object may be identified by a signature (also referred to as an object fingerprint), which, in some implementations, may include a cryptographic hash digest of the content of that object. The signature can be correlated to a physical address (i.e., disk location) of the object's data in an object index.

Further, in some examples, the objects in the data store 110 may be hierarchically arranged. Such hierarchical arrangement of the objects may be referred to as a file system instance or a hive. For illustration purpose, the data store 110 is shown to include such file system instance 114 (labeled in FIG. 1 as “FSI”). It is understood that, in some examples, the data store 110 may also include additional file system instances without limiting the scope of the present disclosure. Objects in the file system instance 114 may represent a hierarchical arrangement of one or more objects stored in the object store 110. One or more objects in a given file system instance, e.g., 114, may be related to a root object in an object tree (e.g., a Merkle tree) or any other hierarchical arrangement (e.g., directed acyclic graphs, etc.). In the case of the object tree, the lowest level tree node of any branch (that is, most distant from the root object) is a data object that stores user data, also referred to as a leaf data object. The parent tree node of the leaf data objects is a leaf metadata object that stores, as its content, the signatures of its child leaf data objects. The root and internal nodes of the object tree may also be metadata objects that store as content the signatures of child objects. A metadata object may be able to store a number of signatures that is at least equal to a branching factor of the hierarchical tree, so that it may hold the signatures of all of its child objects.

Each file system instance in the data store 110 may be dedicated to an entity, such as a particular virtual machine or virtual controller, a user, a database, or a client. By way of example, in FIG. 1, in the description hereinafter, the file system instance 114 will be described as being dedicated to the resource 120. In particular, the file system instance 114 may represent a hierarchical arrangement of files and/or directories associated with the resource 120. In the examples where there are more than one resources hosted on the computing node 102, the data store 110 may also include one or more additional file system instances dedicated to the additional resources. Additional details regarding the file system instance 114 will be described in conjunction with FIG. 2.

The data store 110 may be implemented, maintained, and managed, at least in part, by a virtual controller, such as, the virtual controller 116. By way of example, the virtual controller 116 may be implemented using hardware devices (e.g., electronic circuitry, logic, or processors) or any combination of hardware and programming (e.g., instructions stored on the machine readable medium 106) to implement various functionalities described herein. For example, the virtual controller 116 may be a virtual machine hosted on the hypervisor 108. The virtual controller 116 may include, at least in part, instructions stored on the machine readable medium 106 and executing on the processing resource 104.

In some examples, the virtual controller 110 may implement file protocol unit (not shown) based on a file access protocol such as server message block (SMB) v3, for example. A client such as the hypervisor 108 may connect with the virtual controller 116 via an IP address of the virtual controller 116 and communicate data access requests to the virtual controller 116 using the file access protocol, such as SMB v3. The data access requests may include requests such as a file open, read, write, rename, move, close, or combinations thereof. The file protocol unit may receive the data access requests and make corresponding system calls to the portions of the virtual controller 116 that manage the data store 110. For example, if the data access request received by the virtual controller 116 is to access the resource 120, the file protocol unit may make open, close, read, or write system calls against the mount point associated with the file system instance 114 in the data store 110.

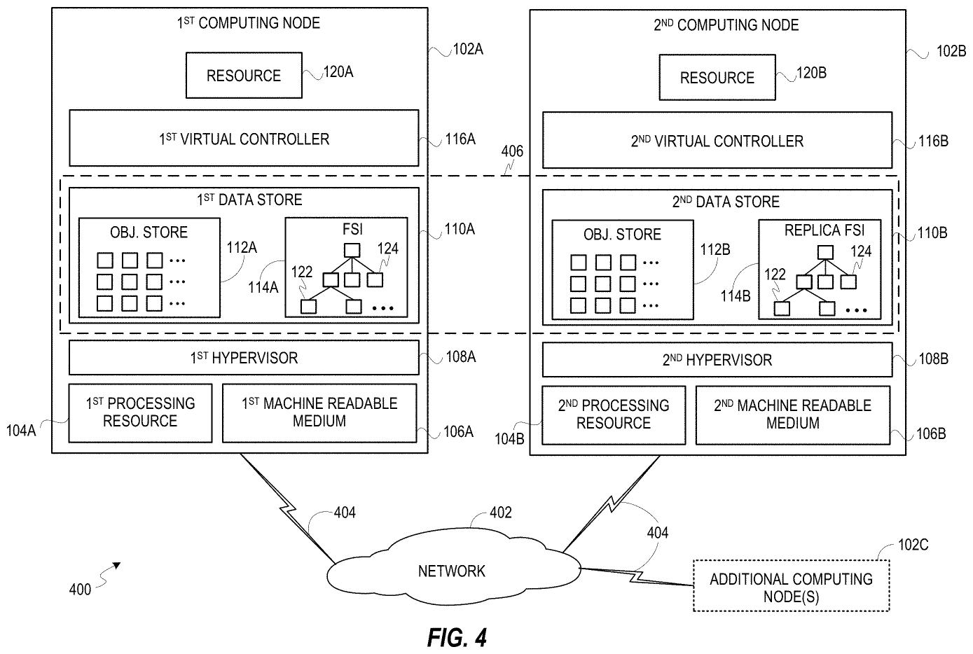

In some examples, to facilitate continuous availability of file data corresponding to a file being accessed, the virtual controller 116 may maintain state information, such as, a persistent handle state information corresponding to each file in the data store 110. For instance, the persistent handle state information may facilitate continuous access of the file by the client in case a connection with a host computing node hosting the file is lost and a reconnect request is received from the client within a time-out duration from the loss of the connection. By way of example, the time-out duration may refer to a maximum duration of time from a discontinuity in access of a file for which the reconnect request may be considered valid. Any reconnect request received after an elapse of the time-out duration may be considered a late reconnect request or invalid reconnect request. In some examples, the persistent handle state information may also facilitate transparent failover in a cluster of computing nodes (see FIG. 4). For example, the persistent handle state information may be available across several computing nodes in the cluster. When a computing node goes down for any reason, the client can use the persistent handle state information to re-establish connection with the file.

Types of the persistent handle state information may include, but are not limited to, an open handle, a share-mode lock handle, and a lease handle. By way of example, the open handle may include information, such as, but not limited to, identification details (e.g., process ID, task ID etc.) of a computing node or application that opens the file, a unique identifier corresponding to the open request for validating a reconnect attempt, information about an owner or sender of the open request (owner ID), an identification of the client (client ID), a disconnect time, or combinations thereof. The disconnect time may represent a time up to which the open handle information is to be retained. Further, the share-mode lock handle may include information, such as, but not limited to, a bit mask to represent which access permissions have been granted for the file, identification information of the file (e.g., File ID), the unique identifier or combinations thereof. Moreover, the lease handle may include information, such as, but not limited to, a current state of a lease (i.e., read, write, or handle), information regarding a lease break message sent to the client and awaiting acknowledgment, or both.

In some examples, when a file in the file system instance 114 is being accessed (i.e., opened), the virtual controller 116 may generate appropriate persistent handle state information. During operation, the client may lose connection with the file being accessed and the client may attempt to access the file by sending a reconnect request to the virtual controller 116. Accordingly, when the reconnect request is received by the virtual controller 116 to access the same file within a timeout duration, the file can be accessed and continuous availability of the data may be maintained. The virtual controller 116 may save the persistent handle state information corresponding to a file in the file system instance in a state file. In some examples, a state file corresponding to each file in the file system instance 114 may be created by the virtual controller 116 to store corresponding persistent handle state information. The persistent handle state information such as the open handle, share mode lock handle, and/or lease handle associated with the file may be stored in the state file.

In accordance with some aspects of the present disclosure, the file and the state file corresponding to the file may be stored in a common file system instance. For example, if a file being accessed is a file associated with the resource 120 and is stored in the file system instance 114, the virtual controller 116 may store the state file corresponding to the file in the same file system instance 114. For example, as depicted in FIG. 1, reference numeral 122 represents a state file (or at least a portion thereof) that contains the persistent handle state information for a file 124. In accordance with some aspects of the present disclosure, the state file 122 corresponding to the file 124 is also stored in the file system instance 114. As such, both the file 124 and the corresponding state file 122 are stored in the common file system instance 114. In some examples, the both the file 124 and the corresponding state file 122 are stored in a common directory in the file system instance 114.

Advantageously, storing both the file and corresponding state file in the same file system instance may lead to improved reliability of the system 100. For instance, as the file 124 and the corresponding state file 122 are stored in the same file system instance 114, as soon as the file system instance 114 is available for access, the state file 122 associated with the file 124 in the file system instance 114 is also available. Accordingly, possibilities for unavailability of the persistent handle state information when the file 124 is accessed may be avoided or minimized. Further, if the state file 122 gets corrupted, only the resource 120 (e.g., virtual machine) corresponding to the corrupted state file 122 would be impacted. Moreover, cleaning of the state file 122 in accordance with the aspects of the present disclosure would be simplified as a traversal of only the state file 122 corresponding to the resource 120 is involved when the resource 120 is accessed by the client. The effort of cleaning of the state file 122 in this manner may be less than that involved with traversing a state file that holds persistent handle state information for all resources hosted on a computing node.

Referring now to FIG. 2, an example detailed view 200 of the file system instance 114 is presented. As previously noted, the file system instance 114 may be dedicated to the resource 120 and store files and directories corresponding to the resource 120. The file system instance 114 may represent hierarchical arrangement of one or more objects 122, 124, 202, 204, 206, and 208 stored in the object store 110. The objects 122, 208, 204, and 124 may represent leaf data object and may store user data while the objects 202 and 206 may represent parent tree objects for the respective leaf data objects as shown in FIG. 2. The parent tree objects 202, 206 may store its content and signatures of its child leaf data objects. By way of example, the object 202 may represent a directory that may store signatures (i.e., address information) of its child or leaf data objects 206, 204, 124. The objects 124 and 204 may be files associated with the resource 120. For example, if the resource 120 is a virtual machine the files 124 and 204 may represent one or more of Resource.vhdx, Resource.vmrs, or Resource.vmcx files.

Further, the object 206 may be a directory, for example, a persistent handle directory that is created by the virtual controller 116 to store state files. Accordingly, the objects 122 and 208 may represent state files each of which contain persistent handle state information for a file. By way of example, the state file 122 may store persistent handle state information corresponding to the file 124. Similarly, the state file 208 may store persistent handle state information corresponding to the file 204. Although, the state files 122 and 208 are represented as child data objects to the persistent handle directory 206, the state files 122 and 208 may also be stored in the file system instance 114 in the similar fashion as files 204, 124. For instance, the state files 122 and 208 may be stored as the child data objects for the directory 202, without limiting scope of the present disclosure. In some examples, the virtual controller 116 may restrict visibility of the persistent handle directory 206. For example, the persistent handle directory 206 may be saved as a hidden directory (represented with dotted outline). Accordingly, the state files in the persistent handle directory 206 may also be hidden.

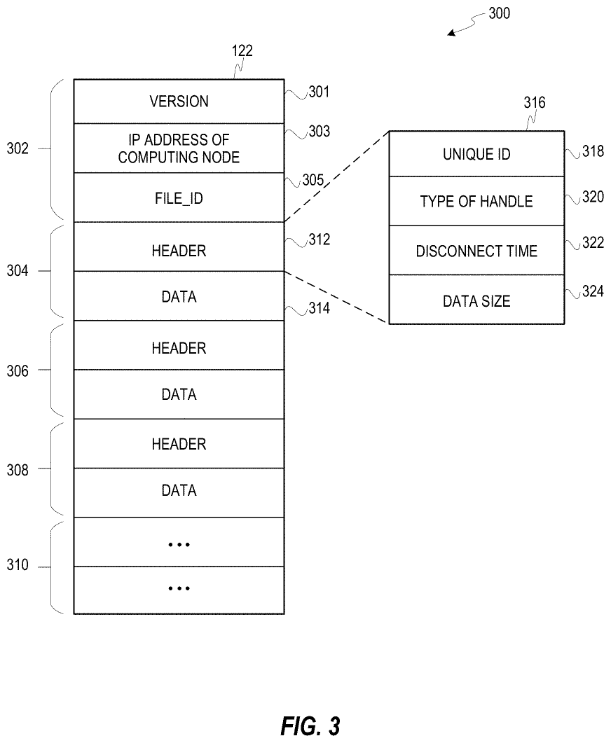

Moving now to FIG. 3, a file format of a state file, such as, the state file 122, is presented, in accordance with an example. In the example file format 300 presented in FIG. 3, the state file 122 may include a pre-header section 302 and one or more record entries 304, 306, 308, 310. The section 310 may represent one or more record entries.

In some examples, the pre-header section 302 of the state file 122 may include fields such as version 301, IP address of computing node 303, and file ID 305. The field - version 301 may represent a version number of the state file 122. The version number of the state file 122 may be updated when a layout of the state file 122 is modified. Moreover, the field—file ID 305 may represent an identifier of the file, such as the file 124, about which the state file 122 holds the persistent handle state information. In particular, the file ID 305 may logically relate or link the state file 122 with the file 124, for example.

The record entries 304-310 may include various persistent handle state information such as the open handle, share mode lock handle, or lease handle. For example, a record entry may relate to any of the open handle, share mode lock handle, or lease handle. In the description hereinafter, format and/or details of the record entry 304 will be described for illustration purpose. Other record entries 306-310 may also have similar format as that of the record entry 304.

The record entry 304 may include a header block 312 and a data block 314. The data block 314 of the record entry 304 may include information corresponding to the open handle, the share mode lock handle, or the lease handle as noted hereinabove. The header block 312 of the record entry 304 may include various metadata information about the persistent handle state represented by the record entry. For example, a view 316 shown in FIG. 3 represents an exploded view of the header block 312 of the record entry 304. As depicted in the exploded view 316, the header block 312 of the record entry 304 may include fields such as, but not limited to, a unique ID 318, a type of handle 320, a disconnect time 322, and a data size 324. The field unique ID 318 may represent a unique identifier (numeric, alphanumeric, or alphabetic) that will be used by the virtual controller 116 to verify and validate any request from the client to access the record entry 304. Further, the field type of handle 320 may represent a type of persistent handle state information such as, the open handle, share mode lock handle, or lease handle, of the record entry 304. Furthermore, the disconnect time 322 may represent a time by which the record entry 304 may become a stale entry. In other words, in some examples, the disconnect time 322 may represent a time until which the record entry 304 remains valid. Finally, the data size 324 may represent a size (e.g., in kilobytes or megabytes) of the data being stored in the data block 314 of the record entry 304.

FIG. 4 illustrates a cluster 400 of computing nodes, in accordance with an example. The cluster 400 of FIG. 4 may include a first computing node 102A and a second computing node 1026 coupled to each other via a network 402. It is to be noted that the computing nodes 102A and 102B may be representative of an example of the computing node 102 of FIG. 1. Therefore, certain details of the computing nodes 102A and 102B have not been repeated herein.

The first computing node 102A may include a first processing resource 104A, a first machine readable medium 106A, a first hypervisor 108A, a first data store 110A having an object store 112A and a file system instance 114A, a first virtual controller 116A, and a resource 120A which may be analogous to components of the computing node 102 of FIG. 1. Similarly, the second computing node 102B may include a second processing resource 104B, a second machine readable medium 106B, a second hypervisor 1086, a second data store 1106 having an object store 1126 and a file system instance 114B, a second virtual controller 116B, and a resource 120B which may be analogous to like components of the computing node 102 of FIG. 1. Further, while both the first and second computing nodes 102A and 1026 are shown to include a resource for illustration, it may be noted that the second computing node 1026 may host different type and/or different number of the resources.

The notations “1^{ST}” and “2^{ND}” as used in FIG. 4 respectively represent the terms “first” and “second” used in the description. Moreover, although the present example of the cluster 400 of FIG. 1 refers to two computing nodes for convenience, the various aspects described herein are also applicable to network systems that include one or more additional computing nodes 102C. The additional computing node(s) 102C may also be an example of the computing node 102 of FIG. 1.

The computing nodes 102A, 102B, 102C may be coupled to the network 402 via communication links 404, as depicted in FIG. 1. The network 402 may refer to a medium that interconnects plurality of computing nodes. Examples of the network 402 may include, but are not limited to, local area network (LAN), wireless LAN (WLAN), metropolitan area network (MAN), wide area network (WAN), and the Internet. Communication over the network 402 may be performed in accordance with various communication protocols such as, but not limited to, Transmission Control Protocol and Internet Protocol (TCP/IP), User Datagram Protocol (UDP), IEEE 802.11n, and cellular communication protocols over the communication links 404. The communication links 404 may be enabled via a wired (e.g., Ethernet, optical communication, etc.) or wireless (e.g., Wi-Fi®, cellular communication, satellite communication, etc.) communication technologies.

In some examples, the data stores 110A and 110B may collectively form a distributed storage 406 that can be accessible by the computing nodes 102A, 102B, and 102C in the cluster 400. By way of example, the data stores 110A and 110B and therefore the distributed storage 406 may represent a virtualized storage enabled by the respective hypervisors 108A, 108B. The distributed storage 406 may include aspects (e.g., addressing, configurations, etc.) abstracted from data stored in a physical storage (not shown). The distributed storage 118 may be presented to a user environment (e.g., to the virtual machines, an operating system, applications, processes, etc.) hosted on one or more of the computing nodes 102A, 102B, 102C.

In some examples, to facilitate high-availability of the data in the cluster 400, the distributed storage 406 may also include one or more replicas of a given file system instance. For instance, a replica file system instance 114B which is maintained as a copy of the file system instance 114 may be stored on the second data store 110B in the second computing node 102B (labeled in FIG. 4 as “REPLICA FSI”). During operation, any update made in the file system instance 114 is also reflected in the replica file system instance 114B. In some examples, for any data write request directed to the resource 120A on the first computing node 102A, the virtual controller 116A may perform the write operation on both the file system instance 114A and the replica file system instance 114B. Accordingly, as long as the replica file system instance 114B is updated by the virtual controller 116A, the replica file system instance 114B may be maintained as the copy of the file system instance 114A. Consequently, entire content of the file system instance 114A including the files and state files is be available on the second computing node 102B as well.

Although not shown, the computing nodes 102-106 may also include several other file system instances dedicated to certain other resources (e.g., virtual machines or databases—not shown) and corresponding replica file system instances stored on a different computing nodes in the cluster 400. For example, a file system instance dedicated to an additional resource (not shown) may be stored in the second data store 110B and a replica file system instance of the same may be stored in the first data store 110B. Such file system instances dedicated to the additional resource may be maintained by the second virtual controller 116B in a similar fashion as file system instance 114A and 114B, as described hereinabove.

During operation of the cluster 400, when a request for accessing the resource 120A is received by the virtual controller 116A from a client, one or more files (e.g., the file 124) corresponding to the resource 120A may be accessed from the file system instance 114A. Depending on the access of the file, for example, the file open request for a file in the file system instance 114A, the virtual controller 116A may generate appropriate persistent handle state information. By way of example, depending on the access, for example, the file open request of the file, the persistent handle state information such as the open handle, the share mode lock handle, and/or the lease handle may be created by the virtual controller 116A.

Further, the virtual controller 116A may save the persistent handle state information corresponding to the file in the file system instance 114A in a state file (e.g., the state file 122). In some examples, the state file corresponding to each file in the file system instance 114 may be created by the virtual controller 116A to store corresponding persistent handle state information. The persistent handle state information such as the open handle, share mode lock handle, and/or lease handle associated with the file may be stored in the state file. In accordance with some aspects of the present disclosure, the state file may be stored in the file system instance to which the corresponding file belongs to. For example, if a file being accessed is a file associated with the resource 120A and is stored in the file system instance 114A, the virtual controller 116A may store the state file corresponding to the file in the same file system instance 114A.

Furthermore, during operation of the cluster 400, a computing node, for example, the first computing node 102A may face failure condition. Accordingly, the first computing node 102A may be considered as failed, down, or facing downtime. By way of example, the failure condition of the first computing node 102A might have been caused due to separation of the first computing node 102A from the network 402, complete or partial failure, damage, and/or malfunctioning of the first computing node 102A or any internal components thereof such as the first virtual controller 116A, the first data store 110A, the first processing resource 104A, and the first machine readable medium 106A.

In some examples, the second computing node 102B may detect failure of the first computing node 102A. Once the failure of the first computing node 102A is detected, a failover process may be initiated which includes IP address switchover and an ownership transfer to the second computing node 102B from the first computing node 102A. Once both the IP address switchover and an ownership transfer to the second computing node 102B are completed, the failover to the second computing node 102B is considered to be completed and the second virtual controller 116B may record a failover timestamp (T_{Failover}). The failover timestamp may be indicative of a time corresponding to completion of the failover to the second computing node 102B.

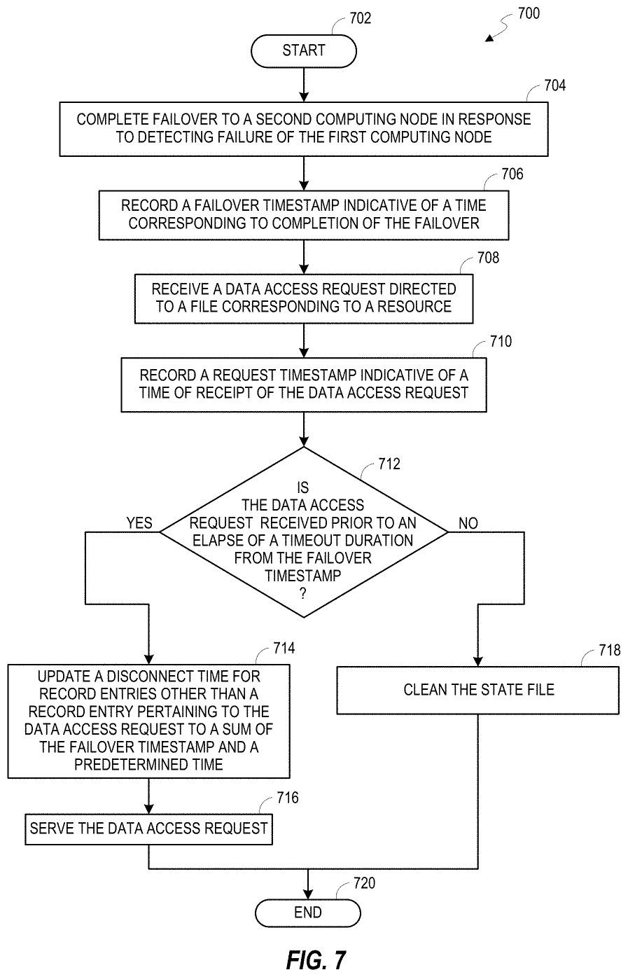

Moreover, during operation of the cluster 400, the second virtual controller 116B may receive a data access request (e.g., a file open request) directed to the resource 120B (same as 120A as the computing node 102B now owns the resource). Further, the second virtual controller 116B may record a request timestamp (T_{DARequest}) indicative of a time of receipt of the data access request. In some examples, the second virtual controller 116B serve the request, deny serving the request, and/or clean one or more record entries in the state files, depending on the request timestamp. Additional details of operations performed by the second virtual controller 116B will be described in conjunction with FIG. 7.

As noted hereinabove, the state files are stored in the same file system instance where files of resource 120A, 120B are stored. In accordance with the aspects of the present disclosure, cleaning (e.g., deleting stale entries) of the state files 122, 208 is carried-out when the data access request directed to the resource 120A/120B is received by the second virtual controller 116B. Also, upon receipt of the data access request, in an example implementation, only the state files such as the state file 122, 208 are cleaned instead of cleaning the state files corresponding to all resources (additional resources are not shown in FIG. 4) hosted on the first computing node 102A. This effort of cleaning of the state files for the resource being accessed may be less in comparison to the effort associated with traversing a state file that holds persistent handle state information for all the resources together. Moreover, in accordance with the aspects of the present application, since the cleaning of the state files is performed when the resource is being accessed rather than cleaning the state files during the failover to the second computing node 102B, the failover process can be completed faster in comparison to other systems.

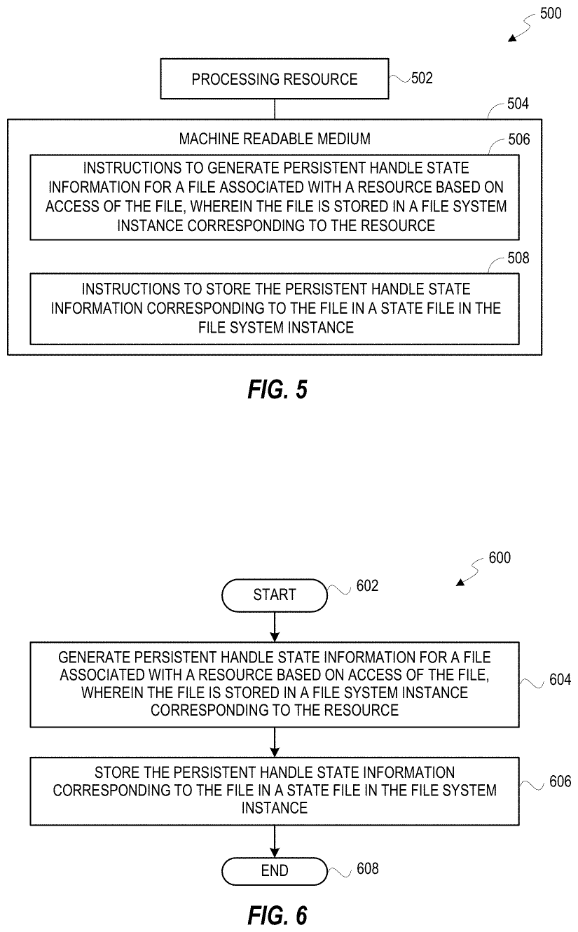

Referring now to FIG. 5, a block diagram 500 depicting a processing resource 502 and a machine readable medium 504 encoded with example instructions to manage persistent handle state information is presented, in accordance with an example. The machine readable medium 504 is non-transitory and is alternatively referred to as a non-transitory machine readable medium 504. In some examples, the machine readable medium 504 may be accessed by the processing resource 502. The processing resource 502 and the machine readable medium 504 may be included in computing nodes, such as the computing node 102 of the system 100 and/or the computing nodes 102A, 102B, 102C of the cluster 400. By way of example, the processing resource 502 may serve as or form part of the processing resources 104, 104A, and/or 104B. Similarly, the machine readable medium 504 may serve as or form part of the machine readable media 106, 106A, and/or 106B.

The machine readable medium 504 may be encoded with example instructions 506 and 508. The instructions 506 and 508 of FIG. 5, when executed by the processing resource 502, may implement aspects of managing persistent handle state information. In particular, the instructions 506 and 508 of FIG. 5 may be useful for performing the functionalities of the virtual controller 116, 116A, and/or 116B and the methods described in FIG. 6. In the description hereinafter, for ease of illustration, the instructions 506 and 508 will be described with reference to the computing node 102 of FIG. 1. As will be appreciated, features described herein are also applicable to the computing nodes 102A, 102B, and 102C of the cluster 400.

The instructions 506, when executed, may cause the processing resource 502 to generate the persistent handle state information for a file associated with a resource based on access of the file. By way of example, by executing the instructions 506, the processing resource 502 may generate the persistent handle state information such as the open handle, share mode lock handle, lease handle, or combinations thereof, for the file 124 (see FIGS. 1-2) associated with the resource 120 when the file 124 is being accessed. As noted earlier, the file 124 is stored in the file system instance 114. Further, in some examples, the instructions 508, when executed, may cause the processing resource 502 to store the persistent handle state information corresponding to the file in a state file in the file system instance. For example, by executing the instructions 508, the processing resource 502 may store the persistent handle state information in the state file 122 that is also stored in the file system instance 114 containing the file 124. In particular, the instructions 506-508 may include various instructions to execute at least a part of the methods described in FIGS. 6-7 (described later). Also, although not shown in FIG. 5, the machine readable medium 504 may also include additional program instructions to perform various other method blocks described in FIGS. 6-7.

FIG. 6 is a flow diagram depicting a method 600 for managing persistent handle state information, in accordance with an example. For ease of illustration, the method 600 will be described with reference to the computing node 102 of FIG. 1. As will be appreciated, features described herein are also applicable to the computing nodes 102A, 1026, and 102C of the cluster 400.

The method 600 begins at block 602 followed by execution of block 604. At block 604, the method 600 includes generating, by a processor based system such as the virtual controller 116, persistent handle state information for a file associated with a resource based on access of the file. As noted earlier, the processing resource 502 may generate the persistent handle state information such as the open handle, share mode lock handle, lease handle, or combinations thereof, for the file 124 (see FIGS. 1-2) associated with the resource 120 when the file 124 is being accessed, where the file 124 is stored in the file system instance 114.

Further, at block 606, the method includes storing, by the processor based system, the persistent handle state information corresponding to the file in a state file in the file system instance. For example, the virtual controller 116 may store the persistent handle state information in the state file 122 that is also stored in the file system instance 114 containing the file 124. In some examples, the state file 122 corresponding to the file 124 may be stored in the directory 202 at a same tree level as that of the file 124. In some examples, the method 600 at block 606 may also include creating, by the processor based system, a persistent handle directory in the file system instance corresponding to the resource. For example, the virtual controller 116 may create the persistent handle directory 206 (see FIG. 2) in the file system instance 114 corresponding to the resource 120. Once the persistent handle directory 206 is created, the virtual controller 116 may store the state file 122 corresponding to the file 124 may be stored in the persistent handle directory 206. Other state files such as the state file 208 corresponding to the file 204 may also be stored in the persistent handle directory 206. In some examples, the virtual controller 116 may create a file a corresponding state file together. For example, the state file 122 may be created when the file 124 is created.

Referring now to FIG. 7, a method 700 of managing the persistent handle state information in case of a failure of a computing node in a cluster, in accordance with an example. For ease of illustration, the method 600 will be described with reference to the second computing node 1026 of FIG. 4. As will be appreciated, features described herein are also applicable to the computing nodes 102 of FIG. 1 and computing nodes 102A and 102C of the cluster 400.

The method 700 begins at block 702 followed by execution of block 704. At block 704, the method 700 includes completing failover to the second computing node 102B in response to detecting failure of the first computing node 102A. In some examples, the second virtual controller 116B may detect the failure of the first computing node 102A by monitoring heartbeat signals generated by the first computing node 102A. The heartbeat signal may be a signal generated by hardware such as the first processing resource 104A or software of the first computing node 102A to indicate normal operation of the first computing node 102A. The heartbeat signal may be received by the second node 102B over the network 402 or over any other private communication link (not shown) between the first computing node 102A and the second computing node 102B. In some examples, the second virtual controller 116B may detect the failure of the first computing node 102A by monitoring acknowledgement or response signals from the first computing node 102A. It may be noted that the present disclosure is not limited with respect to methods to detecting failure of the first computing node 102A.

Once the failure of the first computing node 102A is detected, a failover process may be initiated. In some examples, the failover process may include an IP address switchover and an ownership transfer to the second computing node 102B from the first computing node 102A. The IP address switchover to the second computing node 102B includes assigning the IP address of the first virtual controller 1166 to the second virtual controller 116B. Further, the ownership transfer to the second computing node 102B includes assigning rights of updating the file system instance 1146 to the second virtual controller 116B. Once both the IP address switchover and an ownership transfer to the second computing node 1026 are completed, the failover to the second computing node 102B is considered to be completed.

Further, at block 704, the method 700 may include recording a failover timestamp (T_{Failover}) indicative of a time corresponding to completion of the failover to the second computing node 102B. For example, the second virtual controller 1166 may record a time of completion of the failover as the failover timestamp. The second virtual controller 116B may store the failover timestamp in a memory (e.g., machine readable medium 106B) associated with the second virtual controller 1166.

Moreover, during operation the cluster 400, a data access request (e.g., a file open request) directed to the resource 120A may be received by the second computing node 102B at block 708. For example, the data access request directed to the resource 120 may be received by the second virtual controller 116B. Furthermore, at block 710, the method 700, may include recording a request timestamp (T_{DARequest}) indicative of a time of receipt of the data access request. For example, the second virtual controller 1166 may record the time of receipt of the data access request as the request timestamp. The second virtual controller 1166 may store the request timestamp in the memory (e.g., machine readable medium 106B) associated with the second virtual controller 116B.

Additionally, at 712, the method may include performing a check to determine whether the data access request is received prior to completion of a time-out duration (Tₜᵢₘₑ₋ₒᵤₜ) from the failover timestamp. The second virtual controller 116B may perform the check at block 712 based on the failover timestamp, the request timestamp, and the time-out duration. In some examples, the second virtual controller 116B may determine a difference (ΔT) between the request timestamp and the failover timestamp.

ΔT=T_{DARequest}−T_{Failover} Equation (1)

Further, the second virtual controller 116B may compare the difference between the request timestamp and the failover timestamp with the time-out duration. The difference between the request timestamp and the failover timestamp being smaller than the time-out duration (i.e., ΔT<Tₜᵢₘₑ₋ₒᵤₜ) indicates that the data access request has been received prior to elapse of the time-out duration from the failover timestamp. However, the difference between the request timestamp and the failover timestamp being greater than the time-out duration (i.e., ΔT>Tₜᵢₘₑ₋ₒᵤₜ) indicates that the data access request has been received after the elapse of the time-out duration from the failover timestamp.

The data access request received at block 708 may correspond to a record entry from the record entries 304-310 in the state file 122. At block 712, if the second virtual controller 116B determines that the data access request has been received prior to the elapse of the time-out duration from the failover timestamp, at block 714, the second virtual controller 116B may update the disconnect time for record entries other than a record entry pertaining to the data access request. In particular, the disconnect time in the header block of the record entries other than the record entry corresponding to the data access request is updated to a sum of the failover timestamp and the time-out duration (T_{Failover}+Tₜᵢₘₑ₋ₒᵤₜ). By way of example, if the data access request received at block 708 relates to a record entry 304 in the state file 122, the disconnect time in the header blocks of the remaining record entries 306, 308, and 310 is updated to the sum of the failover timestamp and the time-out duration (T_{Failover}+Tₜᵢₘₑ₋ₒᵤₜ). Further, the disconnect time in the header block of the record entry may be maintained as 0 (zero). Further, at block 716, the second virtual controller 116B may serve the data access request. By way of example, serving the data access request at block 716 may include performing an operation as desired in the data access request in the file system instance 114B.

At block 712, if the second virtual controller 116B determines that the data access request has not been received prior to the elapse of the time-out duration from the failover timestamp, at block 718, the second virtual controller 116B may clean the state file. In particular, cleaning of the state file at block 718 may include deleting one or more record entries having the disconnect time earlier than the request timestamp (i.e., stale entries). In some examples, the second virtual controller 116B may delete the stale entries in the state file (e.g., the state file 122) corresponding to the file being accessed (e.g., the file 124) in the file system instance 114B. In some examples, the second virtual controller 116B may delete the stale entries in all of state files (e.g., the state file 122, 208) in the file system instance 114B.

In some examples, when a resource (hereinafter cloned resource), for example a virtual machine, is created by cloning an existing resource (e.g., an existing virtual machine), a new file system instance for the cloned resource is created. The file system corresponding to the cloned resource may be a copy of a file system instance corresponding to the existing resource. Therefore, in the file system instance corresponding to the cloned resource, the state files associated with files of the existing resource are also copied since the state files are stored in the file system instance of the existing resource. It is to be noted that the files in the file system corresponding to the cloned resource may get a new file ID whereas content inside the file may remain same as the corresponding file associated with the existing resource.

After the creation of the cloned resource, when a file open request is received for a given file associated with the cloned resource, a state file corresponding to the given file may be deleted. In some examples, upon receipt of the file open request for the given file, the virtual controller of the computing node hosting the cloned resource may compare the file ID 305 in the pre-header section 302 of the state file corresponding to a file ID associated with the given file. Because the file ID 305 contained in the state file corresponds to a file in the existing resource, the file ID 305 may not match with the file ID associated with the given file of the cloned resource. Accordingly, the virtual controller of the computing node hosting the cloned resource may delete the state file corresponding to the given file in the file system instance of the cloned resource. In certain examples, based on such comparison of the file ID 305, the virtual controller of the computing node hosting the cloned resource may delete all the state files copied from the existing resource to the file system instance of the cloned resource.

In the foregoing description, numerous details are set forth to provide an understanding of the subject matter disclosed herein. However, implementation may be practiced without some or all of these details. Other implementations may include modifications, combinations, and variations from the details discussed above. It is intended that the following claims cover such modifications and variations.

What is claimed is:

1. A method comprising:
generating, by a processor based system, persistent handle state information for a file associated with a resource based on access of the file, wherein the file is stored in a file system instance corresponding to the resource; and
storing, by the processor based system, the persistent handle state information corresponding to the file in a state file in the file system instance.

2. The method of claim 1, wherein the resource comprises a virtual machine, a database, a client, an application, a container, a containerized application, a folder, or combinations thereof.

3. The method of claim 1, further comprising creating, by the processor based system, a persistent handle directory in the file system instance corresponding to the resource, wherein the state file corresponding to the file is stored in the persistent handle directory.

4. The method of claim 3, further comprising restricting, by the processor based system, a visibility of the persistent handle directory.

5. The method of claim 1, wherein the persistent handle state information for the file comprises an open handle, a share mode lock handle, a lease handle, or combinations thereof, and wherein the method further comprising storing a record entry corresponding to one or more of the open handle, the share mode lock handle, or the lease handle, in the state file corresponding to the file.

6. The method of claim 5, wherein the state file comprises a version number, an IP address of a computing node hosting the file system instance, identifier of the file, and the record entry, or combinations thereof, wherein the record entry comprises a header block and a data block, and wherein the header block comprises a unique identifier, a persistent handle type, a disconnect time, and a data size of the persistent handle state information.

7. The method of claim 1, wherein the resource is hosted on a first computing node in a cluster of computing nodes, and wherein the cluster of the computing nodes further comprises a second computing node coupled to the first computing node via a network, wherein the method further comprising:
completing failover to the second computing node in response to detecting failure of the first computing node; and
recording a failover timestamp indicative of a time corresponding to completion of the failover.

8. The method of claim 7, further comprising:
receiving a data access request directed to the file corresponding to the resource; and
recording a request timestamp indicative of a time of receipt of the data access request.

9. The method of claim 8, further comprising updating, upon receipt of the data access request, a disconnect time for record entries other than a record entry pertaining the data access request to a sum of the failover timestamp and a time-out duration, wherein the data access request is received before an elapse of the time-out duration from the failover timestamp.

10. The method of claim 9, further comprising serving the data access request, wherein the data access request is received prior to an elapse of the time-out duration from the failover timestamp.

11. The method of claim 9, further comprising cleaning the state file upon receiving the data access request, wherein the data access request is received after an elapse of the time-out duration from the failover timestamp, wherein cleaning the state file comprises deleting a record entry having the disconnect time earlier than the request timestamp.

12. A system comprising:
a resource hosted on a first computing node;
a first data store hosted on the first computing node comprising a file system instance corresponding to a resource, wherein the file system instance comprises a file associated with the resource;
a first virtual controller hosted on the first computing node, wherein the first virtual controller is to:
generate persistent handle state information for the file based on access of the file; and
store the persistent handle state information corresponding to the file in a state file in the file system instance corresponding to the resource.

13. The system of claim 12, wherein the first virtual controller creates a persistent handle directory in the file system instance corresponding to the resource and stores the state file in the persistent handle directory.

14. The system of claim 1, wherein the first computing node is coupled in a cluster, wherein the cluster comprises a second computing node coupled to the first computing node via a network, wherein the second computing node comprises a second virtual controller, and a second data store comprising a replica file system instance that is a copy of the file system instance, and wherein the second virtual controller is to:
record a failover timestamp indicative of a time corresponding to completion of the failover to the failover computing node upon failure of the computing node;
receive a data access request directed to the file corresponding to the resource; and
record a request timestamp indicative of a time of receipt of the data access request.

15. The system of claim 14, wherein the first virtual controller maintains the replica file system instance in synchronization with the file system instance on the first computing node.

16. The system of claim 14, wherein the second virtual controller updates, upon receipt of the data access request, a disconnect time in for record entries other than a record entry pertaining to the data access request to a sum of the failover timestamp and a time-out duration, wherein the data access request is received before an elapse of the time-out duration from the failover timestamp.

17. The system of claim 16, wherein the second virtual controller further deletes a record entry having the disconnect time earlier than the request timestamp, wherein the data access request is received after an elapse of the time-out duration from the failover timestamp, wherein cleaning the state file comprises.

18. The system of claim 16, wherein the second virtual controller serves the data access request received prior to an elapse of the time-out duration from the failover timestamp.

19. A non-transitory machine readable medium storing instructions executable by a processing resource, the instructions comprising:
instructions to generate persistent handle state information for a file associated with a resource based on access of the file, wherein the file is stored in a file system instance corresponding to the resource; and
instructions to store the persistent handle state information corresponding to the file in a state file in the file system instance.

20. The non-transitory machine readable medium of claim 19, further comprises instructions to create a persistent handle directory in the file system instance corresponding to the resource and stores the state file in the persistent handle directory.
